(19) United States
(12) Patent Application Publication
(10) Pub. No.: US 2009/0140709 A1
(43) Pub. Date: Jun. 4, 2009

(54) CURRENT-LIMITING VOLTAGE CONVERSION DEVICE

(76) Inventors: MING-YAO DONG, Chupei (TW); Wen-Hsing Chang, Chupei (TW)

Correspondence Address: G. LINK CO., LTD., 3550 BELL ROAD, MINOOKA, IL, 60447, US

(21) Appl. No.: 11/949,974

(22) Filed: Dec. 4, 2007

(51) Int. Cl. G05F 1/00

(52) U.S. Cl. 323/283; 323/285

(57) ABSTRACT

The present invention relates to a current-limiting voltage conversion device, comprising a voltage conversion unit, a voltage signal unit, a sensor unit and a DC power loop. The voltage conversion unit and the sensor unit are electrically connected in series in the DC power loop. The voltage signal unit outputs a corresponding voltage signal to the voltage conversion unit based on the electric signal output by the sensor unit, and the voltage conversion unit controls the voltage conversion of the voltage conversion unit based on said voltage signal. The voltage signal unit includes outputting a voltage signal corresponding to the power state within a first preset range as detected by the sensor unit and outputting another voltage signal corresponding to the power state within a second preset range as detected by the sensor unit until the power state detected by the sensor unit returns to the first preset range

### FIELD OF THE INVENTION

The present invention relates to a current-limiting voltage conversion device, characterized in which the characteristics of output power from the voltage conversion loop in the current-limiting voltage conversion device is limited.

### BACKGROUND OF THE INVENTION

FIG. 1 is a diagram showing the topology of a conventional current-limiting protection circuit. Said power control circuit comprises an IC chip (A1), an inductor (A2), an electric switch (A3), a resistor (A4), and a diode (A5) to achieve DC voltage control and current limitation. The IC chip (A1) consists of a first port (A11), a second port (A12), and a third port (A13), the first port being electrically connected to the electric switch (A3), the second port (A12) and the third port (A13) being respectively electrically connected to either end of the resistor (A4). The IC chip (A1) provides a control signal via the first port (A11) to control the ON/OFF of the electric switch (A3), and measures the step voltage of resistor (A4) via the second port (A12) and the third port (A13). The inductor (A2) is for storing and releasing energy, and the inductor (A2) is electrically connected to the electric switch (A3) and the resistor (A4) in such sequence to form an electric series. The electric switch (A3) is a MOSFET switch or any electric switch that can be turned on or off through an electric signal. The diode (A5) is for preventing the reverse current.

In the aforesaid power control circuit, when the IC chip (A1) turns the electric switch (A3) on, the current from the inductor (A2) would flow through in sequence the electric switch (A3) and the resistor (A4), whereas the output voltage of the power control circuit is obtained by controlling the ON cycle of the electric switch (A3) via the IC chip (A1). At the same time, a voltage drop is formed at two ends of the resistor (A4), and the IC chip (A1) can sense the voltage drop via the first electric endpoint (A6) and the second electric endpoint (A7) and feed it back into the IC chip (A1) as reference for electric switch (A3) control. When the current passing through the resistor (A4) is excessive, the step voltage across the resistor (A4) will reach a default reference voltage in the IC chip (A1) such that the IC chip (A1) would output a control signal via the first port (A11) to turn off the electric switch (A3), hence achieving simultaneously the purposes of controlling the output voltage and limiting the current of the power control circuit.

However the aforesaid design is unable determine the stability of the output voltage/current. Thus to address the drawback of prior current-limiting voltage conversion device, the invention aims to provide a circuit that uses fixed resistance, but is able precisely and dynamically control the input/output voltage and current, and stabilize the voltage output.

### SUMMARY OF THE INVENTION

The primary object of the present invention is to provide a current-limiting voltage conversion device, which, through a voltage signal unit coupled with a feedback unit, is able to control the DC energy storage and release mechanism of the voltage conversion unit and outputs specific voltage power.

To achieve the aforesaid object, the invention provides a current-limiting voltage conversion device, comprising a voltage conversion unit being a voltage-converting loop with DC energy storage and release mechanism; a voltage signal unit being a voltage signal output apparatus and outputting electric signal with specific voltage value; a sensor unit being a power state sensor and outputting an electric signal to the voltage signal unit corresponding to the power state sensed; and a DC power loop. The voltage conversion unit and the sensor unit are electrically connected in series in the DC power loop. The voltage signal unit outputs a voltage signal to the voltage conversion unit corresponding to the electric signal output by the sensor unit, and the voltage conversion unit would control its voltage conversion according to said voltage signal. The voltage signal unit consists of outputting a voltage signal corresponding to the power state within the first preset range as detected by the sensor unit and outputting another voltage signal corresponding to the power state within a second preset range as detected by the sensor unit until the power state detected by the sensor unit returns to the first preset range. Thus when the amperage detected by the sensor unit is less than or equal to a preset range, the voltage conversion loop would convert the input DC power into a constant voltage power for output; when the amperage detected by the sensor unit is greater than the preset range, the voltage conversion loop would reduce the voltage of output power so that the amperage detected by the sensor unit would go back to the preset range. As such, the control of the voltage conversion loop is achieved by carrying out boost conversion to keep the output voltage constant or reducing the voltage output by the voltage conversion loop after the boost conversion to further limit the amperage of the DC power loop.

In addition, the voltage signal unit may be replaced by a microcontroller, the microcontroller carrying out corresponding control through logic operation.

The object, features and functions of the invention are described in detail with examples and accompanying drawings below.

### BRIEF DESCRIPTION OF THE DRAWINGS

FIG. 1 is a diagram showing the topology of a conventional current-limiting protection circuit;

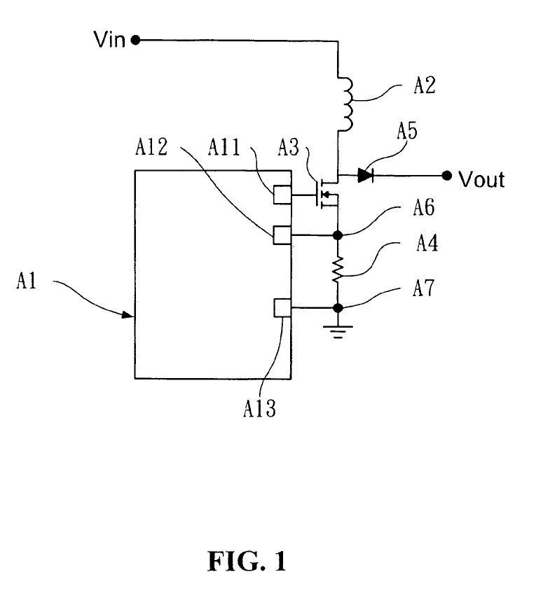

FIG. 2 is a component diagram of the current-limiting voltage conversion device according to a first embodiment of the invention;

FIG. 3 is a component diagram of the current-limiting voltage conversion device according to a second embodiment of the invention;

FIG. 4 is a component diagram of the current-limiting voltage conversion device according to a third embodiment of the invention;

FIG. 5 is a component diagram of the current-limiting voltage conversion device according to a fourth embodiment of the invention;

FIG. 6 is a component diagram of the current-limiting voltage conversion device according to a fifth embodiment of the invention;

FIG. 7 is a component diagram of the current-limiting voltage conversion device according to a sixth embodiment of the invention;

FIG. 8 is a component diagram of the current-limiting voltage conversion device according to a seventh embodiment of the invention;

FIG. 9 is a component diagram of the current-limiting voltage conversion device according to an eighth embodiment of the invention; and

FIG. 10 is a component diagram of the current-limiting voltage conversion device according to a ninth embodiment of the invention;

### DETAILED DESCRIPTION OF THE INVENTION

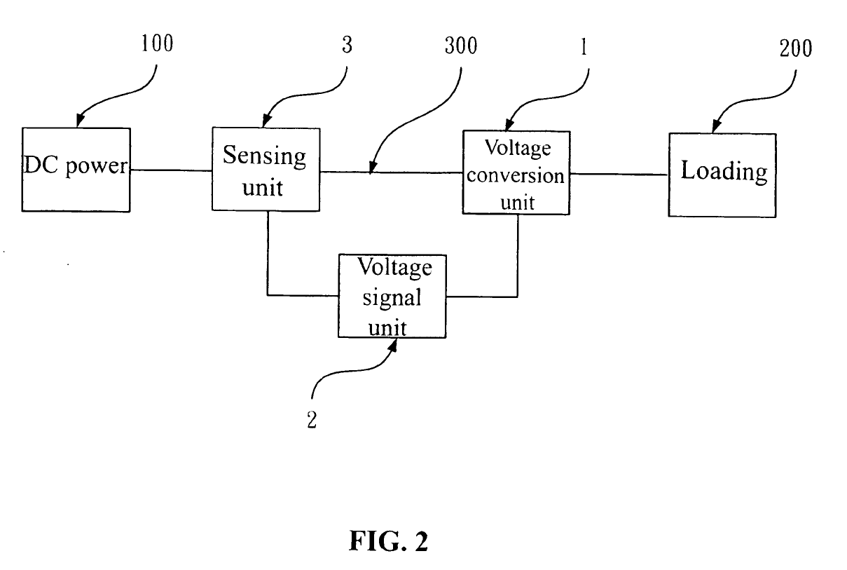

FIG. 2 a component diagram of the current-limiting voltage conversion device according to a first embodiment of the invention. As shown, the current-limiting voltage conversion device of the invention comprises mainly a voltage conversion unit (1), a voltage signal unit (2), a sensor unit (3), and a DC power loop (300) such that DC power output by a DC power source (100) can be transmitted via the DC power loop (300) to the voltage conversion unit (1) where the DC power voltage is converted into a DC power of specific voltage for output, and the DC power with converted voltage is transmitted to the loading (200) via the DC power loop (300). Moreover, the sending unit (3) is able to detect the current, voltage or power state of the DC power loop (300) and feed the detected information in the form of a corresponding signal to the voltage signal unit (2), which would then output a corresponding voltage signal based on the signal fed by the sensor unit (3) to the voltage conversion unit (1) so as to control the operation of the voltage conversion unit (1). When the power detected by the sensor unit (3) falls within a first preset range, the voltage signal unit (2) would output a corresponding voltage signal so as to control the voltage conversion unit (1) to convert the input DC power into steady-voltage power for output; when the power detected by the sensor unit (3) falls within a second preset range, the voltage signal unit (2) would output another corresponding voltage signal so as to control the voltage conversion unit (1) to convert the input DC power into specific-voltage power for output so that the power characteristics detected by the sensor unit (3) can return to the first preset range.

The sensor unit (3) is a power sensor device for sensing the voltage or current of the DC power output by the DC power loop (300) such that the current-limiting voltage conversion device of the invention can, in reference to the electric signal fed back by the sensor unit (3), control the DC power conversion ratio of the voltage conversion unit (1) or stop its DC power conversion, thereby protecting the current-limiting voltage conversion device, or the DC power source (100) that supplies DC power to the voltage conversion unit (1) as well as the loading (200).

Moreover, when the sensor unit (3) is a current detector, it can be electrically serially connected in the DC power loop (300) and oppose the high side or low side of the DC power source (100) or loading (200).

The current sensing loop in the sensor unit (3) composed of a resistor (31) and a voltage differential amplifier (32) can also be any other device capable of sensing the output current of the DC power loop (300) without electrically serially connected in part to said DC power loop (300). For example, the sensor unit (3) contains a Hall Element to detect the output current of the DC power loop (300).

In the current-limiting voltage conversion device, the voltage conversion loop (11) in the voltage conversion unit (1) is a DC power boost circuit, a DC power buck circuit or a DC power boost-buck circuit.

In the aforesaid embodiment, the voltage conversion controller (12), the feedback unit (13), the voltage-dividing unit (21), the voltage signal unit (2), and the sensor unit (3) can be electrically connected into an integrated circuit (IC).

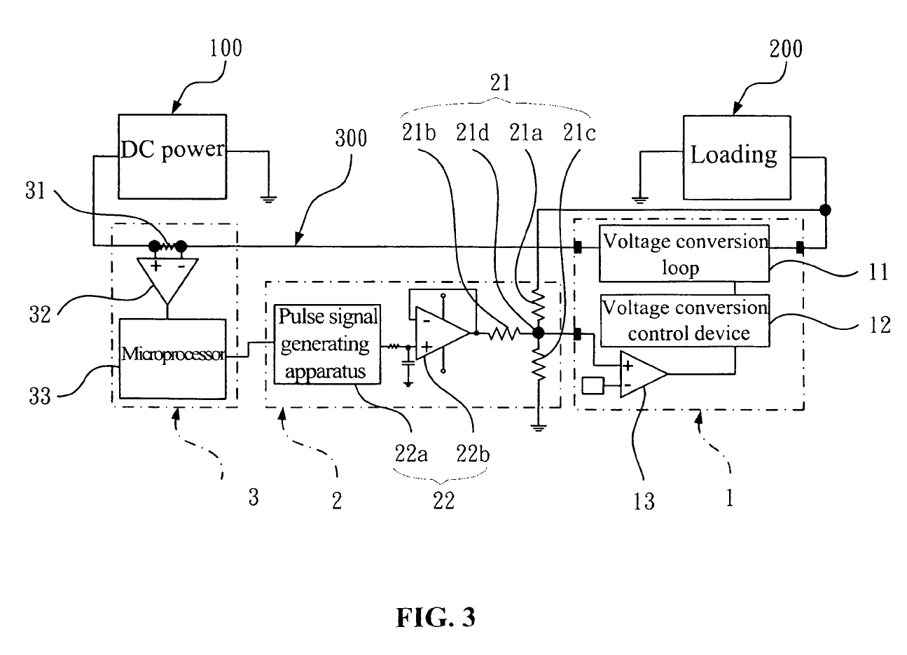

FIG. 3 is a component diagram of the current-limiting voltage conversion device according to a second embodiment of the invention. As shown, the voltage conversion unit (1) further comprises a voltage conversion loop (11) which is a circuit capable of energy storage and release for the input DC power and forms an electrical series connection in the DC power loop (300) where the voltage signal provided by the voltage signal unit (2) controls the operation of the voltage conversion loop (11). Moreover, the sensor unit (3) further comprises a resistor (31), a voltage differential amplifier (32) and a microprocessor (33). The resistor (31) is electrically serially connected to the resistor in the DC power loop (300). The voltage differential amplifier (32) is a voltage differential amplification loop composed of operational amplifier, the two input ends of the voltage differential amplifier (32) being electrically and parallelly connected to two sides of the resistor (31) to compare the voltage difference between two sides of the resistor (31), and based on which, a corresponding electric signal being output from the output end of the voltage differential amplifier (32). The microprocessor (33) has logic operation and logic control means to carry out logic operation based on the electric signal output by the voltage differential amplifier (32) and output a corresponding electric signal to control the output of a corresponding voltage signal by the voltage signal unit (2). As such, under the microprocessor (33) control and the corresponding operation of the voltage conversion unit (1), the monitoring and control of amperage in the DC power loop (300) are achieved.

The voltage conversion unit (1) further comprises a voltage conversion controller (12) and a feedback unit (13). The voltage corversion controller (12) chooses to turn on or off the DC energy storage and release mechanism of the voltage conversion unit (1) to achieve the conversion of DC power voltage; the voltage conversion controller (12) being an electric loop capable of logic operation and control, and choosing to turn on or off the DC energy storage and release mechanism of the voltage conversion unit (1) based on the electric signal fed back by the feedback unit (13). The feedback unit (13) is electrically connected to the voltage signal output end of the voltage signal unit (2) at one end, and based on the voltage signal output by the voltage signal unit (2), outputs a corresponding electric signal to the voltage conversion controller (12). In the example where the voltage conversion loop (11) is a booster loop, the electric signal output by the sensor unit (3) would be converted into a voltage signal after passing through the voltage signal unit (2) and fed to the feedback unit (13) of the voltage conversion unit (1). Next, the feedback unit (13) would output an electric signal corresponding to the voltage signal output by the voltage signal unit (2) and fed it to the voltage conversion controller (12). Finally, the voltage conversion controller (12) would choose the on or off the DC energy storage and release mechanism of the voltage conversion unit (1) based on the electric signal output by the feedback unit (13). Thus when the amperage detected by the sensor unit (3) is less than or equal to a preset range, the voltage conversion loop (11) would convert the input DC power into a constant voltage power for output; when the amperage detected by the sensor unit (3) is greater than the preset range, the voltage conversion loop (11) would reduce the voltage of output power so that the amperage detected by the sensor unit (3) would go back to the preset range. As such, the control of the voltage conversion loop (11) is achieved by carrying out boost conversion to keep the output voltage constant or reducing the voltage output by the voltage conversion loop (11) after the boost conversion to further limit the amperage of the DC power loop (300).

The feedback unit (13) can be a voltage differential amplifier with an input end being electrically connected to the output end of the voltage signal unit (2), another input end being electrically connected to a reference voltage, and an output end being electrically connected to the voltage conversion controller (12). The feedback unit (13) outputs the conversion result to the voltage conversion controller (12), which then outputs a duty cycle signal based on said conversion result to control the selection of energy storage or release mechanism by the voltage conversion loop (11), thereby achieving voltage conversion.

In the current-limiting voltage conversion device just described, the voltage signal unit (2) can further include a voltage-dividing unit (21) and a voltage generating apparatus (22), the voltage-dividing unit (21) further comprising a first resistor (21a), a second resistor (21b), a third resistor (21c), and a voltage signal output end (21d), the other end of the first resistor (21a) being electrically connected to the output end of the voltage conversion loop (11) in the DC power loop (300), the other end of the second resistor (21b) being electrically connected to the output end of the voltage generating apparatus (22), and the other end of the third resistor (21c) being electrically connected to a voltage level end. The voltage generating apparatus (22) outputs a voltage signal to the second resistor (21b) of the voltage-dividing unit (21) corresponding to the electric signal output by the sensor unit (3). Thus the voltage at the voltage signal output end (21d) should be the same as the reference voltage, while the voltage output by the voltage conversion loop (11) will form an interdependent relationship with the voltage at the output end of the voltage signal unit (2) due to the action of the voltage-dividing unit (21) composed of the first resistor (21a), the second resistor (21b) and the third resistor (21c).

More specifically, in the current-limiting voltage conversion device, the voltage generating apparatus (22) in the voltage signal unit (2) further comprises a pulse signal generator (22a) and a pulse-to-voltage converter loop (22b). The pulse signal generator (22a) is an electric apparatus that generates pulse signal and outputs a pulse signal with specific duty cycle based on the control signal provided by the microprocessor (33). The pulse-to-voltage converter loop (22b) outputs a corresponding voltage signal based on the magnitude and duty cycle of pulse signal provided by the pulse signal generator (22a) and transmits the voltage signal to the electric connection end of the voltage-dividing unit (21) and voltage signal unit (2).

The pulse-to-voltage converter loop (22b) can also be a voltage follower to reduce the effect of output end.

The pulse signal generator (22a) in the voltage signal unit (2) can, through the width modulation of the output pulse signal, regulate the voltage output by the pulse-to-voltage converter loop (22b) to the voltage-dividing unit (21).

In the current-limiting voltage conversion device just described, the microprocessor (33) compares the signal received from the sensor unit (3) with the preset voltage, current or power value, and then outputs a corresponding control signal to the pulse signal generator (22a) in the voltage signal unit (2), and at the same time, outputs a control signal to the pulse signal generator (22a) to enable it to output an electric signal of specific duty cycle to the pulse-to-voltage converter loop (22b) and transmit it to the voltage-dividing unit (21). Next, according to the Kirchhoff's current law, the voltage at the voltage signal output end (21d) of the voltage-dividing unit (21) would vary with the voltage at the current output end of the voltage conversion loop (11). Furthermore, the voltage conversion controller (12) would choose to turn on or off the DC energy storage and release mechanism of the voltage conversion loop (11) based on the input voltage at the voltage signal output end (21d) such that the voltage conversion loop (11) will undergo corresponding voltage conversion, and the feedback unit (13) will determine the magnitude of voltage at the voltage signal output end (21d) and output a corresponding electric signal to the voltage conversion controller (12). Voltage conversion controller (12) then chooses to turn on or off the DC energy storage and release mechanism of the voltage conversion unit (1) based on the electric signal fed back by the feedback unit (13) to achieve the conversion of DC power voltage of the voltage conversion unit (1). The voltage conversion controller (12) can output an electric signal with specific duty cycle to control the voltage conversion loop (11) such that the voltage conversion loop (11) is switched to ON or OFF state in correspondence to said electric signal so as to achieve the conversion of DC power voltage of the voltage conversion loop (11).

The feedback unit (13) contains a voltage differential amplifier and a reference voltage apparatus, and the output end of the voltage differential amplifier amplifies the voltage difference between the voltage signal output end (21d) and the reference voltage apparatus and outputs a corresponding electric signal to the voltage conversion controller (12).

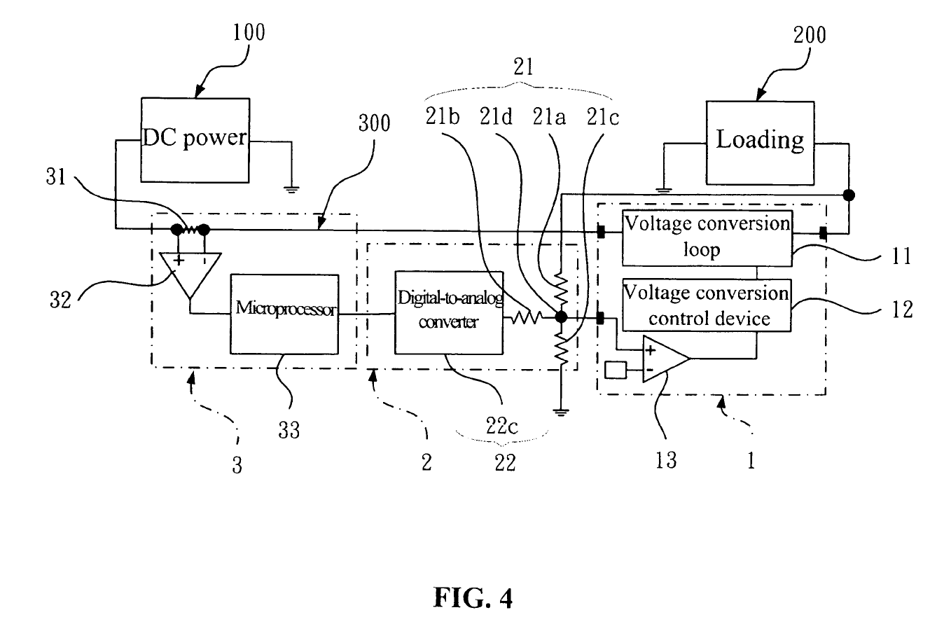

FIG. 4 is a component diagram of the current-limiting voltage conversion device according to a third embodiment of the invention. In reference to the first and the second embodiments of the invention, the voltage generating apparatus (22) in the voltage signal unit (2) further consists of a digital-to-analog converter (22c), wherein the signal input end of the digital-to-analog converter (22c) is electrically connected to the microprocessor (33) and its signal output end is electrically to the second resistor (21b) of the voltage-dividing unit (21). The microprocessor (33) in the sensor unit (3) can generate a digital signal corresponding to the electric signal provided by the voltage differential amplifier (32) in the sensor unit (3) and provide it to the digital-to-analog converter (22c) where the digital signal is converted into an analog voltage signal which is provided to the voltage-dividing unit (21) to control the magnitude of voltage at its voltage signal output end (21d) according to the Kirchhoff's current law.

In the current-limiting voltage conversion device described above, the transient instance when the voltage signal unit (2) outputs a voltage signal to the second resistor (21b) of the voltage-dividing unit (21), the voltage at the voltage signal output end (21d) would observe the Kirchhoff's current law that the voltage at the node which the first resistor (21a) electrically connected with the DC power loop (300) is dependent on the voltage signal output end (21d).

Similarly, the feedback unit (13) transmits an electric signal corresponding to the voltage at the voltage signal output end (21d) of the voltage-dividing unit (21) to the voltage conversion controller (12). The voltage conversion controller (12) would then choose to turn on or off the DC energy storage and release mechanism of the voltage conversion unit (1) such that the voltage conversion unit (1) would output a corresponding voltage to the DC power loop (300) and the voltage signal output end (21d) of the voltage-dividing unit (21) reaches the state of corresponding potential. Not until the voltage output by the voltage conversion unit (1) to the loading (200) becomes the predetermined voltage would the voltage at the voltage signal output end (21d) reaches a steady state or fluctuates in a narrow range.

In reference to the current-limiting voltage conversion device described above, the microprocessor (33) compares the signal received from the sensor unit (3) with the preset voltage, current or power value, and then outputs following computation a corresponding digital signal to the digital-to-analog converter (22c) in the voltage signal unit (2), and similarly, the voltage signal unit (2) outputs a corresponding analog signal to the second resistor (21b) of the voltage-dividing unit (21). Next, according to the Kirchhoff's current law, the voltage at the voltage signal output end (21d) of the voltage-dividing unit (21) would vary with the voltage at the current output end of the voltage conversion loop (11). Furthermore, the voltage conversion controller (12) in the voltage conversion unit (1) would choose to turn on or off the DC energy storage and release mechanism of the voltage conversion loop (11) based on the input voltage at the voltage signal output end (21d) such that the voltage conversion loop (11) will undergo corresponding voltage conversion

In addition, the voltage conversion unit (1) can convert the voltage at the voltage signal output end (21d) of the voltage-dividing unit (21) into a logic signal and pass it on to the voltage conversion controller (12) via the feedback unit (13) so as to determine energy storage or release by the voltage conversion loop (11). Moreover, the feedback unit (13) can compare the voltage at the voltage signal output end (21d) of the voltage-dividing unit (21) with that of the reference voltage apparatus via the voltage differential amplifier to obtain the logic signal. The voltage conversion controller (12) outputs an electric signal with specific duty cycle to determine whether to turn on or off the energy storage and release mechanism of the voltage conversion loop (11).

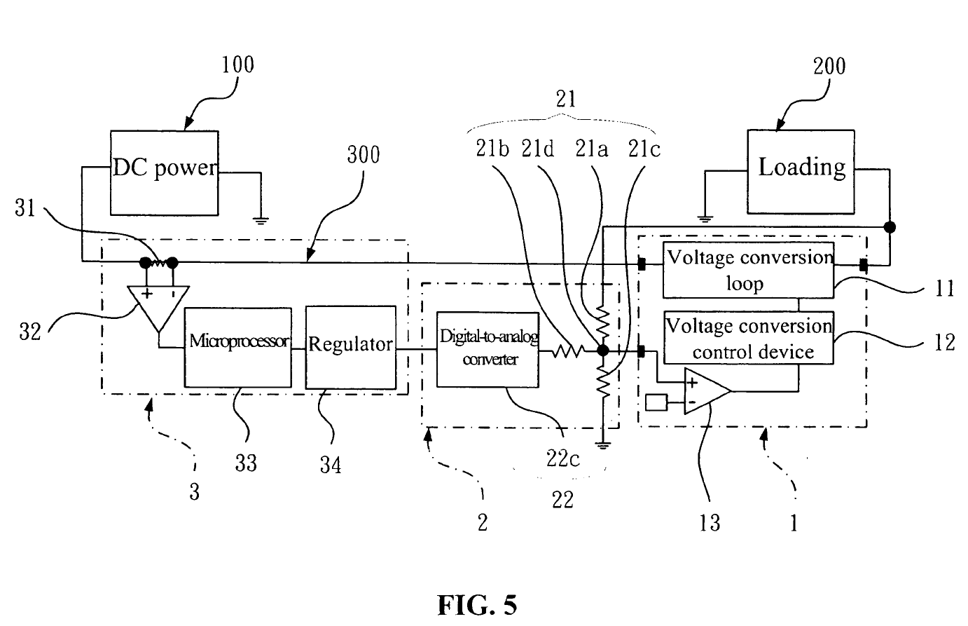

Referring further to FIG. 5 which is a component diagram of the current-limiting voltage conversion device according to a fourth embodiment of the invention, the sensor unit (3) in the current-limiting voltage conversion device according to the third embodiment of the invention further comprises a regulator (34), the regulator (34) being a digital level regulator for regulating the digital signal output by the microprocessor (33) so as to amplify or reduce the voltage signal after conversion by the digital-to-analog converter (22c).

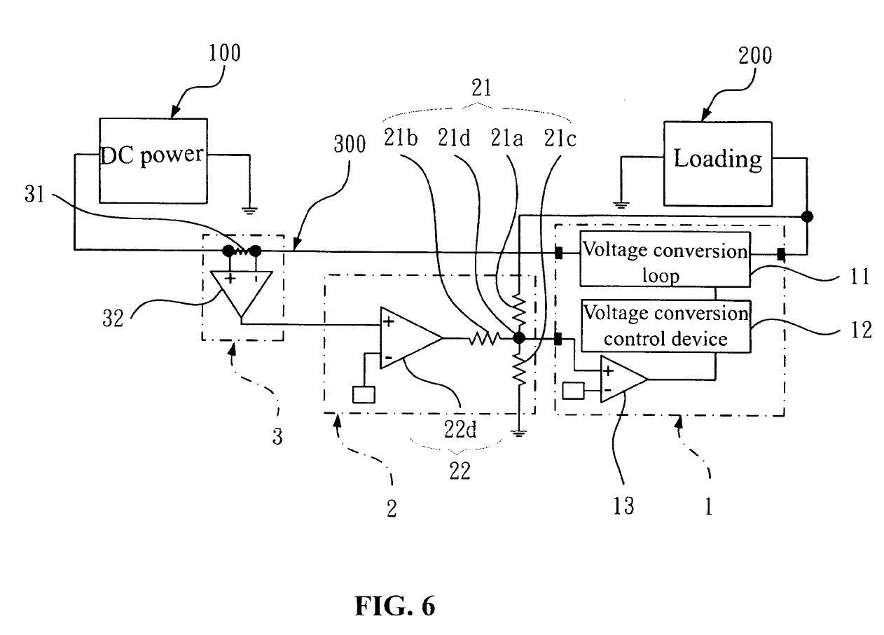

Referring to FIG. 6 which is a component diagram of the current-limiting voltage conversion device according to a fifth embodiment of the invention, the voltage generating apparatus (22) in the voltage signal unit (2) of the current-limiting voltage conversion device described above further comprises a voltage differential amplifier (22d), the voltage differential amplifier (22d) having a reference voltage, an input end being electrically connected to the output end of the sensor unit (3), and an output end being electrically connected to the second resistor (21b) of the voltage-dividing unit (21) such that the voltage differential amplifier (22d) can compare and determine the input voltage of the sensor unit (3), and then output a corresponding voltage signal to the second resistor (21b). The voltage level at the voltage signal output end (21d) of the voltage-dividing unit (21) could therefore be modulated. However the voltage signal output end (21d) of the voltage-dividing unit (21) would still reflect the voltage at the output end of the voltage conversion loop (11).

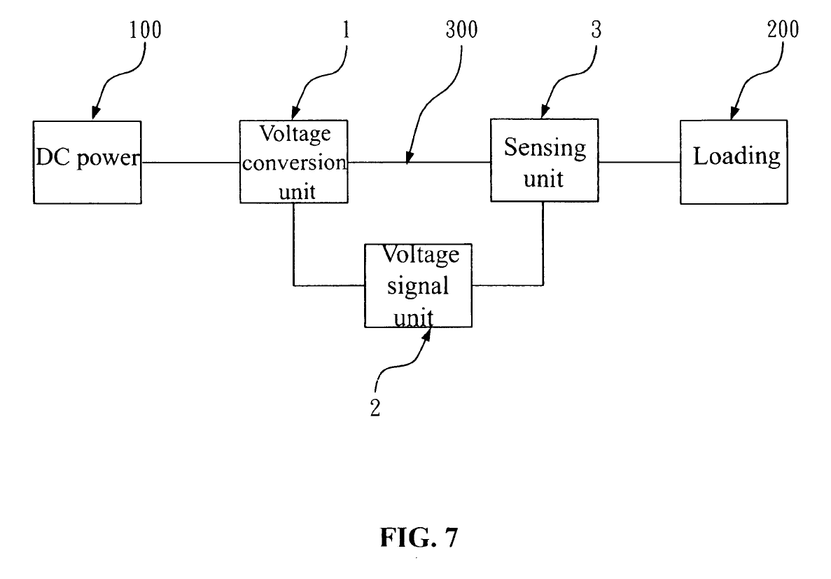

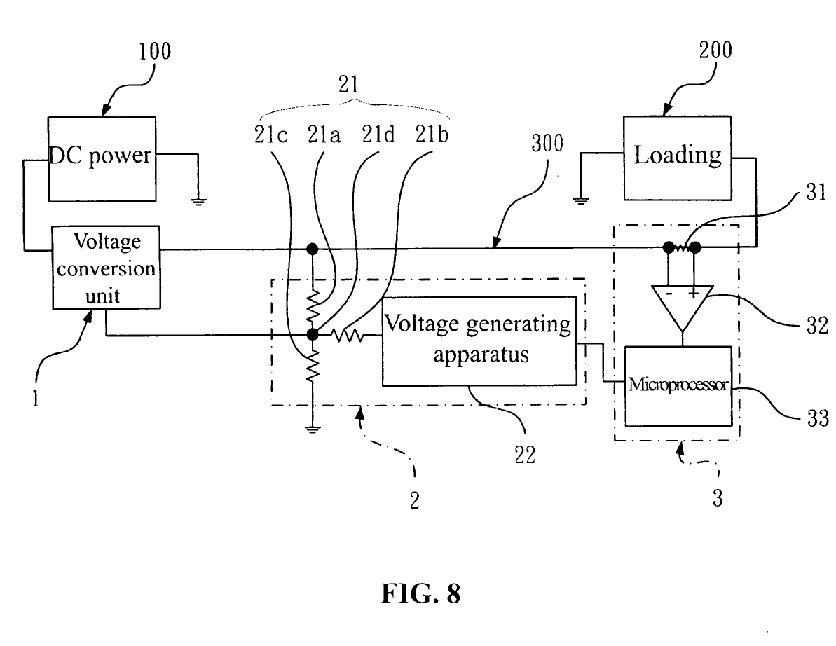

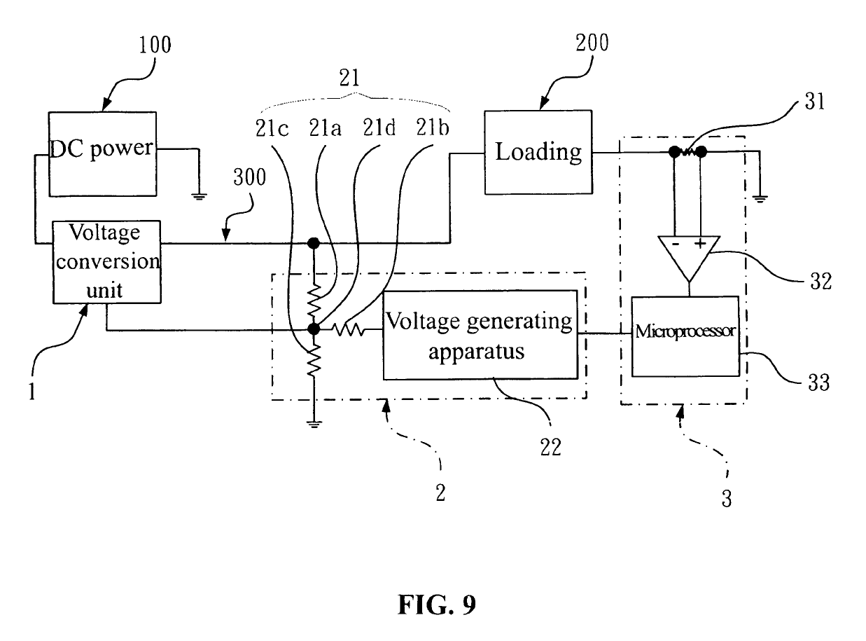

Referring to FIGS. 7, 8 and 9, FIG. 7 is a component diagram of the current-limiting voltage conversion device according to a sixth embodiment of the invention, FIG. 8 is a component diagram of the current-limiting voltage conversion device according to a seventh embodiment of the invention, and FIG. 9 is a component diagram of the current-limiting voltage conversion device according to an eighth embodiment of the invention. In reference to the current-limiting voltage conversion device described above, the sensor unit (3) is disposed in the DC power loop (300) and electrically serially connected to the output end of the voltage signal unit (2). The sensor unit (3) can also be electrical serially connected in the DC power loop (300) and oppose the high side (as shown in FIG. 8) or low side (as shown in FIG. 9) of the loading (200).

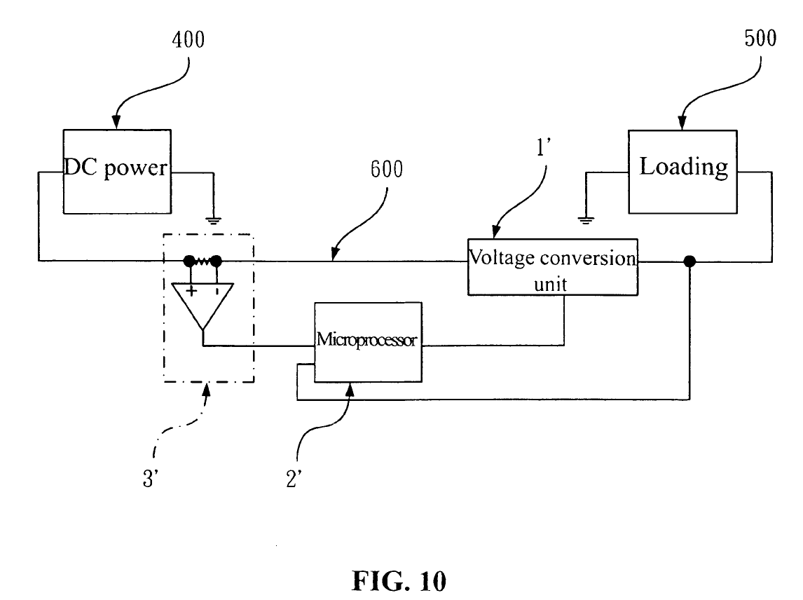

In reference to FIG. 10 which is a component diagram of the current-limiting voltage conversion device according to a ninth embodiment of the invention, the current-limiting voltage conversion device comprises mainly a voltage conversion unit (1′), a microprocessor (2′), a sensor unit (3′), and a DC power loop (600) such that the DC power output by a DC power source (400) can be transmitted to the voltage conversion unit (1′) via the DC power loop (600) to undergo the conversion of DC power voltage and output a specific-voltage DC power. The DC power with converted voltage is then transmitted to the loading (500) via the DC power loop (600) to supply the DC power needed by the loading (500).

In the current-limiting voltage conversion device described above, the voltage conversion unit (1′) is a circuit having an energy storage and release mechanism for the input DC power and electrically serially connected in the DC power loop (600), where the control signal provided by the microprocessor (2′) controls the operation of voltage conversion unit (1′). The microprocessor (2′) is a logic operation and logic control loop having an input end and an output end that can input and output electric signals to respectively provide the feedback signal needed for the logic operation and output the control signal obtained after the logic operation. The sensor unit (3′) can detect the current, voltage or power of the DC power loop (600) and feed a corresponding signal to the microprocessor (2′). The microprocessor (2′) would output a corresponding control signal to the voltage conversion unit (1′) based on the signal fed by the sensor unit (3′) to control the operation of the voltage conversion unit (1′). When the power detected by the sensor unit (3′) falls within a first preset range, the microprocessor (2′) would output a corresponding control signal so as to control the voltage conversion unit (1′) to convert the input DC power into steady-voltage power for output; when the power detected by the sensor unit (3′) falls within a second preset range, the voltage signal unit (2′) would output another corresponding control signal so as to control the voltage conversion unit (1′) to convert the input DC power into specific-voltage power for output so that the power characteristics detected by the sensor unit (3′) can return to the first preset range.

In addition, the other input end of the microprocessor (2′) is electrically connected to the output end of the voltage conversion unit (1′) such that the power voltage converted and output by the voltage conversion unit (1′) can be fed to the microprocessor (2′) so that the microprocessor (2′) can carry out logic operation based on simultaneously the voltage signal output by the sensor unit (3′) and the voltage signal output by the voltage conversion unit (1′) and compare the result with the preset voltage, current or power value. The microprocessor (2′) then transmits the control signal obtained after the logic operation to the voltage conversion unit (1′) to determine whether to turn on or off the DC energy storage and release mechanism of the voltage conversion unit (1′) for the voltage conversion unit (1′) to carry out corresponding voltage conversion.

The preferred embodiments of the present invention have been disclosed in the embodiments. However the embodiments should not be construed as a limitation on the actual applicable scope of the invention, and as such, all modifications and alterations without departing from the spirits of the invention and appended claims shall remain within the protected scope and claims of the invention.

What is claimed is:

1. A current-limiting voltage conversion device, comprising:
a voltage conversion unit being a voltage conversion loop having a DC energy storage and release mechanism;
a voltage signal unit being a voltage signal output device and outputting electric signal with specific voltage:
a sensor unit being a power state sensor and outputting an electric signal to the voltage signal unit corresponding to the power state detected; and
a DC power loop;
wherein the voltage conversion unit and the sensor unit are electrically connected in series in the DC power loop; the voltage signal unit outputs a corresponding voltage signal to the voltage conversion unit based on the electric signal output by the sensor unit, and the voltage conversion unit controls its voltage conversion according to said voltage signal; and the voltage signal unit includes outputting a voltage signal corresponding to the power state within a first preset range as detected by the sensor unit and outputting another voltage signal corresponding to the power state within a second preset range as detected by the sensor unit until the power state detected by the sensor unit returns to the first preset range.

2. The current-limiting voltage conversion device according to claim 1, wherein the sensor unit comprises a resistor and a voltage differential amplifier, the resistor being electrically serially connected in the DC power loop, the two input ends of the voltage differential amplifier being electrically parallelly connected to the two sides of the resistor, the output end of the voltage differential amplifier being electrically connected to the voltage signal unit and outputting an electric signal corresponding to the step voltage of the resistor.

3. The current-limiting voltage conversion device according to claim 2, wherein the sensor unit further comprises a microprocessor, the microprocessor having logic operation and logic control means, carrying out logic operation based on the electric signal output by the voltage differential amplifier and outputting a corresponding electric signal to control the voltage signal output by the voltage signal unit.

4. The current-limiting voltage conversion device according to claim 3, wherein the sensor unit further includes a regulator, the regulator being a digital level regulator for regulating the digital signal output by the microprocessor so as to amplify or reduce the voltage signal converted by a digital-to-analog converter.

5. The current-limiting voltage conversion device according to claim 1, wherein the sensor unit includes a Hall Element, the Hall Element being arranged opposing the DC power loop to detect the output current of the DC power loop.

6. The current-limiting voltage conversion device according to claim 11, wherein the voltage conversion controller, the feedback unit, the voltage-dividing unit, the voltage signal unit and the sensor unit are electrically connected into an integrated circuit.

7. The current-limiting voltage conversion device according to claim 1, wherein the voltage signal unit further comprises a pulse signal generator, a pulse-to-voltage converter loop, and a voltage-dividing unit; the pulse signal generator being an electric apparatus that generates pulse signal with specific duty cycle, the pulse-to-voltage converter loop being an apparatus converting the pulse signal into a voltage signal, and the voltage signal output by the pulse-to-voltage converter loop corresponding to the pulse signal generated by the pulse signal generator; the voltage-dividing unit further comprising a first resistor, a second resistor, a third resistor, and a voltage signal output end, the other end of the first resistor being electrically connected to the output end of the voltage conversion loop in the DC power loop, the other end of the second resistor being electrically connected to the output end of the voltage generating apparatus, and the other end of the third resistor being electrically connected to a voltage level end; the voltage generating apparatus outputting a voltage signal to the second resistor of the voltage-dividing unit corresponding to the electric signal output by the sensor unit.

8. The current-limiting voltage conversion device according to claim 7, the pulse-to-voltage converter loop being a voltage follower.

9. The current-limiting voltage conversion device according to claim 7, wherein the voltage signal unit further comprises a microprocessor, the microprocessor having logic operation and logic control means to control the output of a pulse signal with specific duty cycle.

10. The current-limiting voltage conversion device according to claim 7, wherein the sensor unit comprises a resistor and a voltage differential amplifier, the resistor being electrically serially connected in the DC power loop, the two input ends of the voltage differential amplifier being electrically parallelly connected to the two sides of the resistor, the output end of the voltage differential amplifier being electrically connected to the voltage signal unit and outputting an electric signal corresponding to the step voltage of the resistor.

11. The current-limiting voltage conversion device according to claim 1, wherein the voltage signal unit further comprises a voltage-dividing unit, a digital signal generator, and a digital-to-analog converter; the voltage-dividing unit further comprising a first resistor, a second resistor, a third resistor, and a voltage signal output end, the other end of the first resistor being electrically connected to the output end of the voltage conversion loop in the DC power loop, the other end of the second resistor being electrically connected to the output end of the voltage generating apparatus, and the other end of the third resistor being electrically connected to a voltage level end; the voltage generating apparatus outputting a voltage signal to the second resistor of the voltage-dividing unit corresponding to the electric signal output by the sensor unit; the digital signal generator being a digital signal generating apparatus and electrically connected to the input end of the digital-to-analog converter; the digital-to-analog converter being an apparatus that converts digital signal into analog signal and its output end being electrically connected to the second resistor of the voltage-dividing unit.

12. The current-limiting voltage conversion device according to claim 11, wherein the sensor unit comprises a resistor and a voltage differential amplifier, the resistor being electrically serially connected in the DC power loop, the two input ends of the voltage differential amplifier being electrically parallelly connected to the two sides of the resistor, the output end of the voltage differential amplifier being electrically connected to the voltage signal unit and outputting an electric signal corresponding to the step voltage of the resistor.

13. The current-limiting voltage conversion device according to claim 12, wherein the sensor unit further comprises a microprocessor, the microprocessor having logic operation and logic control means, carrying out logic operation based on the electric signal output by the voltage differential amplifier and outputting a corresponding electric signal to control the voltage signal output by the voltage signal unit.

14. The current-limiting voltage conversion device according to claim 13, wherein the sensor unit further includes a regulator, the regulator being a digital level regulator for regulating the digital signal output by the microprocessor so as to amplify or reduce the voltage signal converted by the digital-to-analog converter.

15. The current-limiting voltage conversion device according to claim 1, wherein the voltage generating apparatus in the voltage signal unit further comprises a voltage-dividing unit and a second voltage comparator; the voltage-dividing unit further comprising a first resistor, a second resistor, a third resistor, and a voltage signal output end, the other end of the first resistor being electrically connected to the output end of the voltage conversion loop in the DC power loop, the other end of the second resistor being electrically connected to the output end of the voltage generating apparatus, and the other end of the third resistor being electrically connected to a voltage level end; the second voltage comparator having a reference voltage, an input end being electrically connected to the output end of the sensor unit, and an output end being electrically connected to the second resistor of the voltage-dividing unit, the second voltage comparator comparing the voltage input by the sensor unit with the reference voltage and outputting a corresponding voltage signal to the second resistor.

16. The current-limiting voltage conversion device according to claim 1, wherein the voltage conversion unit further includes a voltage conversion loop, the voltage conversion loop having a DC energy storage and release mechanism and being a DC power boost circuit, a DC power buck circuit or a DC power boost-buck circuit.

17. The current-limiting voltage conversion device according to claim 16, wherein the voltage conversion unit further comprising a voltage conversion controller and a feedback unit; the voltage conversion controller choosing the on or off of the DC energy storage and release mechanism of the voltage conversion loop to achieve the conversion of DC power voltage; the voltage conversion controller being an electric loop capable of logic operation and control, and choosing the on or off of the DC energy storage and release mechanism of the voltage conversion unit based on the electric signal fed back by the feedback unit; the feedback unit being electrically connected to the voltage signal output end of the voltage signal unit at one end, and based on the voltage signal output by the voltage signal unit, outputting a corresponding electric signal to the voltage conversion controller.

18. The current-limiting voltage conversion device according to claim 17, wherein the feedback unit further comprising a voltage comparator and a reference voltage apparatus, an input end of the voltage comparator being electrically connected to the voltage signal output end of the voltage-dividing unit and another input end being electrically connected to the reference voltage apparatus to compare the voltage at the voltage signal output end with the voltage at the reference voltage apparatus, and output the comparison result to the voltage conversion controller.

19. The current-limiting voltage conversion device according to claim 18, wherein the voltage conversion controller being able to output an electrical signal with specific duty cycle to choose the on or off of the energy storage and release mechanism of the voltage conversion loop.

20. A current-limiting voltage conversion device, comprising:
a voltage conversion loop being a voltage conversion loop having a DC energy storage and release mechanism;
a microprocessor being a logic operation and logic control electric loop having an input end and an output end for the input and output of electric signals respectively:
a sensor unit being a power state sensor and outputting an electric signal to the voltage signal unit corresponding to the power state detected; and
a DC power loop;
wherein the voltage conversion loop and the sensor unit are electrically connected in series in the DC power loop; the microprocessor outputs a corresponding voltage signal to the voltage conversion loop based on the electric signal output by the sensor unit, and the voltage conversion loop controls its voltage conversion according to said voltage signal; and the voltage signal unit includes outputting a voltage signal corresponding to the power state within a first preset range as detected by the sensor unit and outputting another voltage signal corresponding to the power state within a second preset range as detected by the sensor unit until the power state detected by the sensor unit returns to the first preset range.

21. The current-limiting voltage conversion device according to claim 20, wherein the microprocessor comprising an input end being electrically connected to the output end of the voltage conversion loop, the power voltage value output by the voltage conversion loop being fed to the microprocessor, where the microprocessor carries out logic operation based on the voltage signal output by the sensor unit and the voltage signal output by the voltage conversion loop and compares the result with the preset voltage, current or power value, and transmits the control signal obtained following the logic operation to the voltage conversion loop to determine whether to turn on or off the DC energy storage and release mechanism of the voltage conversion loop, and the voltage conversion loop carries out corresponding voltage conversion.
